(19) United States
(12) Patent Application Publication
(10) Pub. No.: US 2008/0028892 A1
(43) Pub. Date: Feb. 7, 2008

(54) DEVICE FOR GRIPPING CAPS FOR A CAPPING MACHINE

(76) Inventor: Sergio Cirio, Canelli (Asti) (IT)

Correspondence Address: PATTERSON & SHERIDAN, L.L.P., 3040 POST OAK BOULEVARD, SUITE 1500, HOUSTON, TX, 77056, US

(21) Appl. No.: 11/691,580

(22) Filed: Mar. 27, 2007

(30) Foreign Application Priority Data
Aug. 7, 2006 (IT) TO2006A000583

(51) Int. Cl. B67B 7/14

(52) U.S. Cl. 81/3.4

(57) ABSTRACT

A device for gripping caps, which can be applied to a capping machine, comprising a support having a hollow guide portion, a connection portion, and a bell-shaped portion and a retention element having a hub portion, which is mounted so that it can slide within said guide portion and is movable with respect to the support between a position of gripping and release of the caps and a position for withholding the caps, in which the retention element is provided with a seat for retention of the caps, which is able to expand in a radial direction, and in which the bell-shaped portion of the support has a contrast surface, which, in a position for withholding the caps, blocks the seat for retention of the caps in the withholding position.

### CROSS-REFERENCE TO RELATED APPLICATIONS

This application claims benefit of Italian patent application number TO2006A000583, filed Aug. 7, 2006, which is herein incorporated by reference.

### BACKGROUND OF THE INVENTION

1. Field of the Invention

The present invention relates to a device for gripping caps for a capping machine.

2. Description of the Related Art

Capping machines for application of caps on bottles or containers are in general normally provided with a head having a member for gripping the caps. The gripping member must be able to pick up and withhold the caps with a force necessary for enabling application of the caps to the container.

In the case where the caps are applied to the container by means of screwing, the gripping member must be able to transmit the screwing torque to the cap.

During the step of application of the caps on the containers, the gripping device must ensure a rather firm gripping of the caps for enabling transmission of the screwing torque. At the same time, the gripping device must enable easy insertion of the caps in the seat of the gripping device and easy release of the same caps at the end of application of the caps on the containers. To ensure said contrasting requirements, it is usually necessary to envisage a controllable actuator, which operates a gripper for gripping and release of the caps.

### SUMMARY OF THE INVENTION

The purpose of the present invention is to provide a device for gripping caps that will enable the aforesaid requirements to be met and has a simple structure and a reduced number of components.

According to the present invention, said purpose is achieved by a device for gripping caps having the characteristics forming the subject of claim 1.

### BRIEF DESCRIPTION OF THE DRAWINGS

The present invention will now be described in detail with reference to the attached plate of drawings, which is provided purely by way of non-limiting example and in which:

FIG. 1 is an axial cross section of a device for gripping caps according to the present invention; and

FIGS. 2 and 3 are axial sections illustrating the device of FIG. 1 in different working positions.

### DETAILED DESCRIPTION

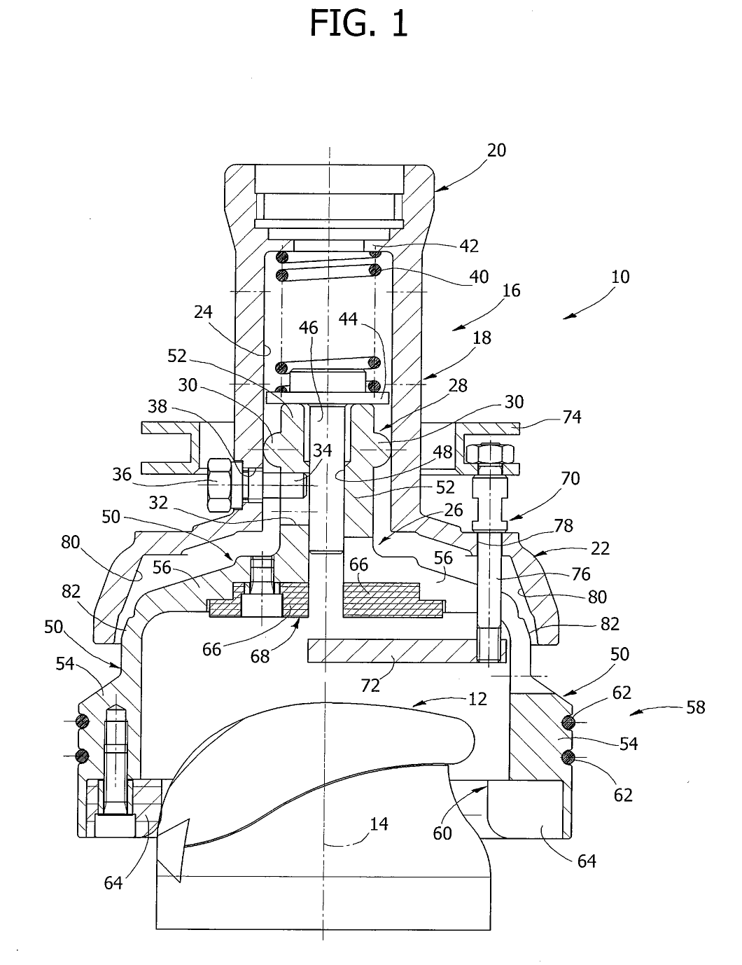

With reference to FIG. 1, the number 10 designates a device for gripping caps according to the present invention. Designated by 12 in FIG. 1 is a cap, which is to be applied to a container (not illustrated). The cap 12 is provided with a thread and is applied on the container by means of a movement of roto-translation consisting of a translation in the direction of an axis 14 and a rotation about the same axis.

The gripping device 10 comprises a support 16 constituted by a metal body having a hollow guide portion 18, a portion of attachment 20, and a bell-shaped portion 22. The attachment portion 20 and the bell-shaped portion 22 are arranged at the opposite ends of the guide portion 18. The guide portion 18 has a cavity 24, preferably of a cylindrical shape, open in a position corresponding to the bell-shaped portion 22. The bell-shaped portion 22 is open at its end with larger diameter, opposite to the guide portion 18.

The gripping device 10 comprises an element for retention of the caps 26 that is intended to carry out gripping and withholding of the caps 12. The retention element 26 comprises a plurality of gripping arms 50, each of which is constituted by a substantially Z-shaped metal element with two generically parallel portions 52, 54 directed parallel to the axis 14 and joined by a generally radial portion 56. The various arms 50 are set alongside one another in a circumferential direction so as to form a member having cylindrical symmetry with a bell-shaped portion 58 and a hub portion 28.

The hub portion 28 of the retention element 26 is formed by the portions 52 set alongside one another of the various arms 50. The portion 52 of each of the arms 50 is provided with a groove elongated in an axial direction 32, which is engaged by a pin-shaped portion 34 of a screw 36 fixed in a radial hole 38 of the guide portion 18. The portions 52 of the arms 50 have respective internal surfaces set alongside one another, which form a cylindrical hole 48, in which a stem 46 is inserted having a dish 44 at one end. The dish 44 rests on the top front ends of the portions 52 of the arms 50. The portions 52 of the arms 50 are preferably provided with projections 30 with semicircular cross section, which slidably engage the internal surface of the cavity 24.

An elastic element 40, preferably constituted by a helical compression spring, is housed in the cavity 24 of the guide portion 18. The elastic element 40 is set in compression between a shoulder 42 of the support 16 and the dish 44. The elastic element 40 tends to push the retention element 26 towards the outside of the support 16. The contact between the portions 34 of the screws 36 with the respective ends of the elongated grooves 32 of the arms 50 defines an end-of-travel position towards the outside of the retention element 26.

The portions 54 of the arms 50 set alongside one another form a seat 60 for gripping and retention of the caps 12.

Applied on the external part of the portions 54 of the retention element 26 are one or more ring-shaped elastic elements 62, which tend to compress the bell-shaped portion 58 of the retention element 26 in a radial direction inwards. The arms 50 constituting the retention element 26 can move in a radial direction outwards against the action of the elastic elements 62. This movement of the arms 50 produces an expansion in a radial direction of the retention seat of the caps 60. The elastic elements 62 tend to bring the arms 26 back towards a position of minimum diameter of the retention seat of the caps 60.

Each of the arms 50 of the retention element 26 is preferably provided with a pad 64 made of plastic material, fixed to the end of the portion 54. The pads 64 of the various arms 50 define, with their internal surfaces, a seat 60 for retention of the caps. The arms 50 forming the retention element 26 are preferably provided with further pads 66 fixed to the radial portions 56 and forming an end surface 68 of the bell-shaped portion 58.

The device 10 according to the present invention can also be provided with an expelling member 70, designed to facilitate expulsion of the caps 12 from the seat 60 after application of the caps 12 on the containers. The expulsion member 70 comprises a pressure element 72 housed within the bell-shaped portion 58 of the retention element 26. The pressure element 72 is movable with respect to the retention element 26 and with respect to the support 16 in the direction of the axis 14. The pressure element 72 is fixed to a control member 74 by means of a plurality of stems 76, just one of which is visible in the figures. The control member 74 has an annular shape, which extends on the outside of the guide portion 18 of the support 16. The stems 76 extend with play through respective holes 78 of the bell-shaped portion 22 of the support 16.

The operation of the gripping device 10 according to the present invention is described in what follows.

With reference to FIG. 1, the gripping device 10 is in the configuration for picking up a cap 12. The retention element 26 is pushed towards the outside of the support 16 by the elastic element 40. The pressure element 72 is in a lowered position under the effect of its own weight. The ring-shaped elastic elements 62 keep the arms 50 constituting the gripping element 26 in their closed position, which corresponds to the minimum diameter of the retention seat 60.

In this configuration, the device 10, carried at the end of a mobile head of a capping machine (not illustrated) is set alongside a cap 12 in the direction of the axis 14. This movement of approach produces insertion of the cap 12 within the bell-shaped portion 58 of the retention element 26. The retention seat 60 expands as a result of the contact of the pads 64 with the external surface of the cap 12. It should be noted that the diameter of the retention seat 60 in the position of rest is smaller than the external diameter of the cap 12. Consequently, during insertion of the cap 12 within the bell-shaped portion 58, the portions 54 of the arms 50 move outwards, causing an expansion in a radial direction of the retention seat 60.

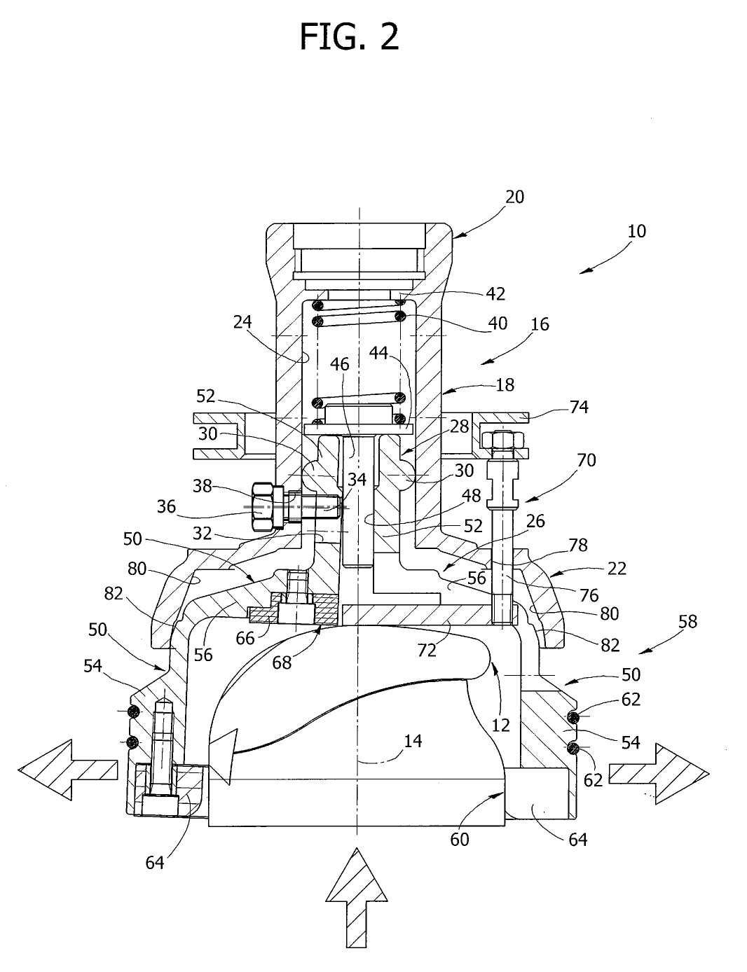

FIG. 2 shows the position of the gripping device 10 after complete insertion of the cap 12 in the bell-shaped portion 58 of the retention element 26. The top of the cap 12 pushes the pressure element 72 and the corresponding control member 74 upwards. The top end of the cap 12 rests against the end surface 68 of the bell-shaped portion 58.

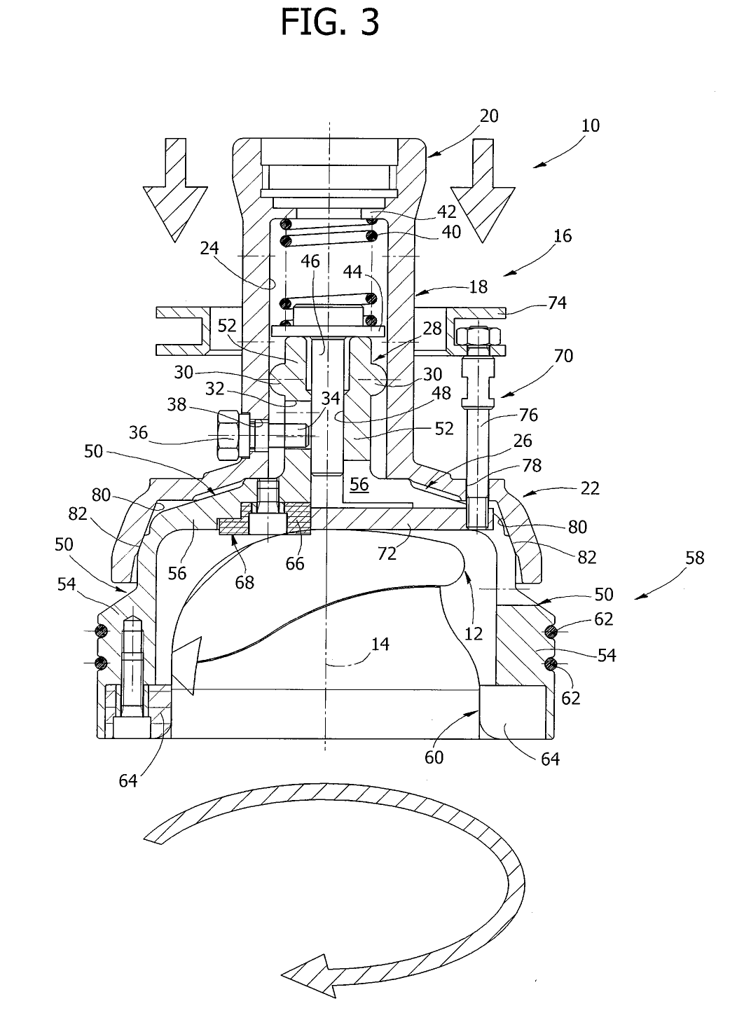

At this point, as the support 16 continues its movement downwards, the retention element 26 moves towards the inside of the support 16. The bell-shaped portion 22 of the support 16 comes into contact with the arms 50, keeping said arms in the position of retention of the cap 12. As may be seen in FIG. 3, the relative movement between the retention element 26 and the support 16 terminates when the radial portions 56 of the arms 50 come into contact with a front surface of the guide portion 18. In this condition, a surface having the shape of a truncated cone 80 of the bell-shaped portion 22 of the support 16 is in contact with corresponding inclined surfaces 82, formed on the external part of the arms 50. The contact between the bell-shaped portion 22 of the support 16 and the arms 50 of the retention element 22 blocks the arms 50 in the configuration of retention of the cap 12. In this condition, the retention element 26 withholds the cap 12 with a force sufficient for transmission of the screwing torque.

At the end of screwing of the cap 12 on the container, the gripping device 10 is moved away in the direction of the axis 14 with respect to the container on which the cap 12 has been applied. The elastic element 40 pushes the retention element 26 towards the outside of the support 16, in this way freeing the arms 50 from engagement with the bell-shaped portion 22 of the support 16. At this point, the seat 60 can be disengaged from the cap 12. Possibly, to facilitate disengagement of the device 10 from the cap 12 it is possible to apply a pressure on the control member 74, as indicated by the arrows 84 in FIG. 3. In this way, a pressure is exerted on the cap 12 via the pressure element, which facilitates disengagement of the cap 12 from the retention element 26.

Of course, without prejudice to the principle of the invention, the details of construction and the embodiments may vary widely with respect to what is described and illustrated herein, without thereby departing from the scope of the invention, as defined by the ensuing claims.

1. A device for gripping caps, which can be applied to a capping machine, comprising:
a support having a hollow guide portion, a connection portion, and a bell-shaped portion; and
a retention element having a hub portion, which is mounted so that it can slide within said guide portion and is movable with respect to the support between a position of gripping and release of the caps and a position for withholding the caps, in which the retention element is provided with a seat for retention of the caps, which is able to expand in a radial direction, and in which the bell-shaped portion of the support has a contrast surface, which, in a position for withholding the caps, blocks the retention seat of the caps in the withholding position.

2. The device according to claim 1, wherein the retention element comprises a plurality of arms, set alongside one another in a circumferential direction, each of said arms including two substantially axial portions joined to one another by a substantially radial portion, in which the first axial portions of the arms form said hub-shaped portion, and in which the second axial portions of the arms form a bell-shaped portion, which is deformable radially outwards and is provided with said seat for retention of the caps.

3. The device according to claim 2, wherein the retention element comprises elastic means tending to maintain the retention portion of the caps in a configuration of minimum diameter.

4. The device according to claim 1, wherein it comprises an elastic compression element, set between the support and the retention element and tending to push the retention element away from the support.

5. The device according to claim 1, wherein it comprises an expelling member including a pressure element housed within the bell-shaped portion of the retention member and connected to a control member, set on the outside of the guide portion of the support.
